(19) United States
(12) Patent Application Publication
(10) Pub. No.: US 2010/0315436 A1
(43) Pub. Date: Dec. 16, 2010

(54) ASSEMBLED DISPLAY DEVICE AND DISPLAY FRAME CONTROL METHOD AND SYSTEM

(75) Inventor: Yi-Hsin CHAN, Taipei (TW)

Correspondence Address: ROGER H. CHU, 19499 ERIC DRIVE, SARATOGA, CA, 95070, US

(73) Assignee: NEXCOM INTERNATIONAL CO. LTD., Chung-Ho (TW)

(21) Appl. No.: 12/792,282

(22) Filed: Jun. 2, 2010

(30) Foreign Application Priority Data
Jun. 10, 2009 (TW) 098119391

(51) Int. Cl. G09G 5/00

(52) U.S. Cl. 345/660

(57) ABSTRACT

The present invention relates to an assembled display device and a display frame control method and system thereof. The assembled display device is installed in a computer system and at least comprises a display frame, which has a graphic controller for the output of image data to a plurality of display screens. The display frame control method comprises the steps of installing a display frame setup program in a computer system; activating the display frame setup program to acquire a setup command, which comprises the information of a specific area of a display frame content corresponding to the image data; subsequently, based on the setup command, controlling a graphic driving program to assemble a control signal in order to output the control signal to the graphic controller; and, based on the control signal, the graphic controller retrieving the information of the specific area of the display frame content corresponding to the image data to be outputted to the display screen and performing a zooming process to the specific area of the display frame.

### BACKGROUND OF THE INVENTION

1. Field of the Invention

The present invention generally relates to a display frame control of a display device, more particularly to a display frame control method and system of an assembled display device.

2. Description of the Prior Art

A display wall is an assembled display device for visual data broadcasting, comprising a plurality of display frame blocks to form a large-scale display. Such display wall is usually found in airports, stations, commercial buildings, shopping malls, open signboards, etc. for showing real-time information or commercial advertisements.

An existing assembled display device is generally composed of a plurality of computer systems, each display screen is connected to a graphic controller of a computer mainframe via a visual interface, and a multimedia display program outputs image data to the display screen for presentation. Conventional graphic controller is able to control the display to present the image data in a full-screen mode. In case that an image is needed to be divided for presentation, the multimedia display program must process the image in advance. In addition, due the limited computer software/hardware resources, a single computer system is incapable of performing a plurality of image division on the display for presentation.

In order to support diverse image sources and types, transform various display types into video formats, perform image division and zooming processes on the image data, and flexibly control the basic display functions, display frames needs to be control by a plurality of computers, and the display operations of all computers are controlled by a display wall server. However, such control structure is not only complicated, but also requires enormous construction costs and maintenance fees.

The problem to be solved in the industry is to simplify the control structure of an assembled display device, in order to reduce the system construction costs and increase the operation convenience and subsequent maintenance. The present invention is disclosed herein to solve the problem.

### SUMMARY OF THE INVENTION

In view of the aforementioned disadvantages and problems of the prior art, the primary objective of the present invention is to provide an assembled display device and a display frame control method and system thereof. The present invention applies a display frame setup program to control a graphic controller to retrieve a specific area of a display frame content on a display frame corresponding to a designated image data, and to perform a zooming process on the specific area; in addition, the present invention enables a single computer system to perform the image division process on the display frame for presentation. Consequently, the present invention not only helps the reduction in system construction costs, but also the increase in the system maintenance for the convenience.

The present invention relates to a display frame control method, which is installed in an assembled display device in a computer system. The assembled display device comprises at least a graphic controller for outputting image data to a display screen. The display frame control method comprises the steps of installing a display frame setup program in the computer system; activating the display frame setup program to acquire a setup command, which comprises the information of a specific area of a display frame content corresponding to the image data; subsequently, based on the setup command, controlling a graphic driving program to assemble a control signal in order to output the control signal to the graphic controller; at last, based on the control signal, the graphic controller retrieving the information of the specific area of the display frame content corresponding to the image data to be outputted to the display based on the control signal, and then performing a zooming process to the display frame of the specific area of the display frame.

The present invention further discloses a display frame control system, which is installed in a computer system to control at least one display screen for presentation. The display frame control system comprises a graphic controller, a graphics driver, a multimedia display program, and a display frame setup program. The graphic controller is coupled with said display screen. The graphic driving program is installed in the computer system to activate the graphic controller. The multimedia display program is installed in computer system to control the graphic driving program to drive the graphic controller in order to output image data to the display frame for presentation. The display frame setup program is installed in the computer system to acquire a setup command, which comprises the information of a specific area of a display frame content corresponding to the image data; the display frame setup program, based on the setup command, controlling the graphic driving program to assemble a control signal to be outputted to the graphic controller. The graphic controller retrieves the information of the specific area of the display frame content corresponding to the image data to be outputted to the display based on the control signal, and then performing a zooming process to the display frame of the specific area of the display frame.

The present invention further provides an assembled display device, which is installed in a computer system, comprising at least a display screen and a display frame control system. The display frame control system comprises a graphic controller, a graphic driving program, a multimedia display program, and a screen setup program. The graphic controller is coupled with display. The graphic driving program is installed in the computer system to activate the graphic controller. The multimedia display program is installed in the computer system to activate the graphic controller in order to output image data to the display for presentation. The display frame setup program is installed in the computer system to acquire a setup command, which comprises the information of a specific area of a display frame content corresponding to the image data; and, based on the setup command, to control the graphic driving program to assemble a control signal to be outputted to the graphic controller. The graphic controller retrieves the information of the specific area of the display frame content corresponding to the image data to be outputted to the display screen based on the control signal, and then performing a zooming process to the display frame of the specific area of the display frame.

Therefore, the assembled display device and the display frame control method and system of the present invention enables the display frame setup program to acquire an external setup command, enables the graphic driving program to controls the graphic controller to retrieve the specific area of the display frame content corresponding to the designated image data to be outputted to the display screen, and then performs a zooming process on the specific area. In addition, the present invention enables the graphic controller to perform an image division process on the display screen for presentation to share the workload of the central processing unit (CPU), so as to enable the present invention to achieve the objective of performing the image division function via a single computer system. Consequently, the present invention not only helps the reduction in system construction costs, but also the increase in the system maintenance for the convenience.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a scheme view of a preferred embodiment showing a hardware system structure of a display frame control system of an assembled display device according to the present invention;

FIG. 2 illustrates a scheme view of the preferred embodiment showing a software system structure of the display frame control system of the assembled display device according to the preferred embodiment of the present invention;

FIG. 3 illustrates a system structure of a graphic controller according to the present invention;

FIG. 4 is a perspective view showing an enlarge view of a portion of a single display frame according to the present invention;

FIG. 5 is a perspective view showing the switch of display frames of an assembled display device according to the present invention;

FIG. 6 illustrates a flow chart of a display frame control method of the assembled display device according to the present invention;

FIG. 7 illustrates a flow chart of the display frame control method of the assembled display device according to the present invention; and

FIG. 8 illustrates a software system structure showing another preferred embodiment of the display frame control system of the assembled display device according to the preferred embodiment of the present invention.

### DETAILED DESCRIPTION OF THE INVENTION

The present invention provides an assembled display device and a display frame control system and a method thereof. The assembled display device is a tiled display wall (TDW), which is a large-scale display, consisting of a plurality of separate display screens, and is constructed to form a matrix of rectangle, square or other specific form.

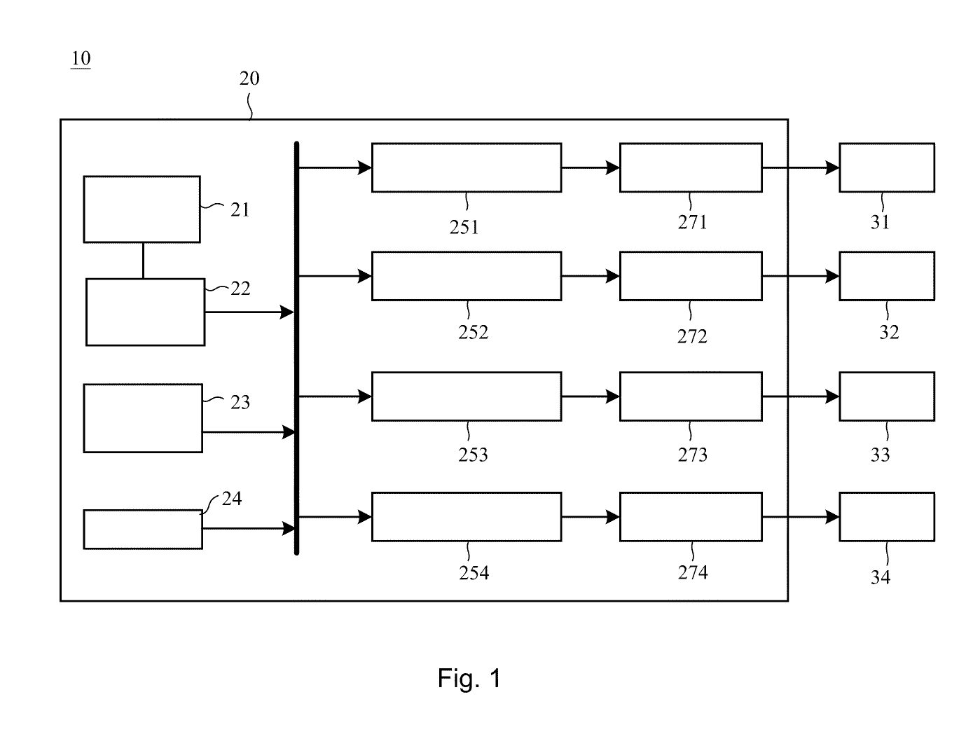

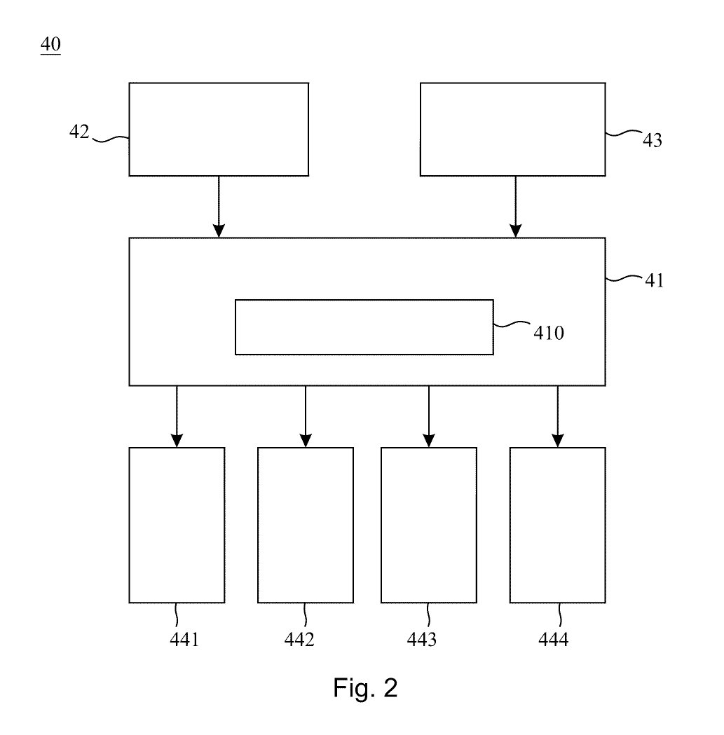

FIG. 1 is a scheme view of a preferred embodiment showing a hardware system structure of a display frame control system of an assembled display device according to the present invention. FIG. 2 illustrates a scheme view of the preferred embodiment showing a software system structure of the display frame control system of the assembled display device according to the preferred embodiment of the present invention. An assembled display device 10 of the present invention is installed in a computer system to apply the software and hardware resources to achieve specific effects based on the present invention.

With the reference to FIG. 1, the hardware of the assembled display device 10 comprises a plurality of display screens 31, 32, 33 and 34 and a display frame control system 20, which is constructed in a computer mainframe, comprising a central processing unit (CPU) 21, a System-on-Chip (SoC) 22, a system memory (RAM) 23, a video source 24, a plurality of graphic controllers 251, 252, 253 and 254 and a plurality of visual interfaces 271, 272, 273 and 274.

The central processing unit (CPU) 21 is the brain of the computer system and is coupled to the graphic controllers 251, 252, 253 and 254 via the bridge System-on-Chip (SoC) 22. The system memory (RAM) 23 cooperates with the central processing unit (CPU) 21 to properly process various operations and store data. The video source 24 is related to image data source and is able to be a data storage media for storing system files, CDs and HDDs, etc., in addition, to connect COM port for external image database transmission. Said image database is stored and transmitted in the video compression bitstream format, which conforms to a video compression standard as MPEG-1, MPEG-2, MPEG-4, H.264, etc. According to the video compression standard, each video image is divided into a plurality of display groups, which are composed of a plurality of frame data. During the transmission of the image data, the plurality of frame data are encoded and quantified, according to the video compression standard, and then, transmitted according to pre-set frame frequency. The graphic controllers 251, 252, 253 and 254 are respectively coupled with the display screens 31, 32, 33 and 34 through the visual interfaces 271, 272, 273 and 274 to acquire image data from the video source 24; subsequently, the data is decoded to a plurality of original frame data for zooming process, and then, the plurality of frame data are encoded into different signal formats that conform to the visual interfaces 271, 272, 273 and 274 respectively and outputted to the display screens 31, 32, 33 and 34.

The assembled display device 10 comprises one or a plurality of display screens. In the preferred embodiment, there are a total of four display screens 31, 32, 33 and 34 as an example. The display frame control system 20 corresponds to the four graphic controllers 251, 252, 253 and 254 and the visual interfaces 271, 272, 273 and 274, and the amounts of the components are not limited to the present invention. The graphic controllers 251, 252, 253 and 254 are coupled with the System-on-Chip (SoC) 22; nevertheless, the graphic controllers are able to be integrated in the central processing unit (CPU) and the System-on-Chip (SoC) or the plurality of graphic controllers are able to be packaged as a single module.

With reference to FIG. 2, a computer system comprises an operating system 41, a multimedia display program 42 and a display frame setup program 43. A plurality of graphic driving programs 441, 442, 443 and 444 are installed in the operating system 41 to individually activate the graphic controllers 251, 252, 253 and 254.

The multimedia display program 42 is an application program and installed in a computer system to open a user interface to acquire an image projection command, and then, control the graphic driving programs 441, 442, 443, and 444 to drive the graphic controllers 251, 252, 253, and 254 to output image data to the display screens 31, 32, 33 and 34, according to the image projection command. The display frame setup program 43 is another application program and installed in the computer system to control the retrieval of a specific area of a display frame content corresponding to the image data. When the display frame setup program 43 is activated, a user interface is opened to acquire a setup command, which comprises the detailed information on the specific area to be retrieved. The display frame setup program 43, based on the setup command, controls the graphic driving programs 441, 442, 443, and 444 to form control signals to be outputted to the graphic controllers 251, 252, 253, and 254. Subsequently, the graphic controllers 251, 252, 253 and 254, based on the control signals, the graphic controllers respectively retrieve a specific area of a display frame content corresponding to a designated image data to be outputted to the display screens 31, 32, 33 and 34, and perform a zooming process on the specific area according to respective display screen widths and heights, so that the specific area is able to be expanded to a full screen for presentation.

The operating system 41 comprises an application programming interface (API) 410 as the communication interface among the multimedia display program 42, the display frame setup program 43 and the graphic driving programs 441, 442, 443, and 444. When the multimedia display program 42 generates a system call after acquiring said image projection command, and controls the graphic driving programs 441, 442, 443, and 444 to drive the graphic controllers 251, 252, 253 and 254 for outputting the image data to the display screens 31, 32, 33 and 34 through the application programming interface (API) 410. Similarly, the display frame setup program 43 generates a system call after acquiring the setup command and controls the graphic driving programs 441, 442, 443, and 444 to form a plurality of control signals to be outputted to the graphic controllers 251, 252, 253, and 254 through the application programming interface (API) 410.

The design details of the display frame setup program 43 are prior arts. The persons skilled in the arts may compile suitable programs according to the descriptions of the present invention, the selections of different languages and the specific call commands of different format graphic driving programs to achieve required functions, so that the compiling of the display frame setup program 43 will not be described any further hereinafter.

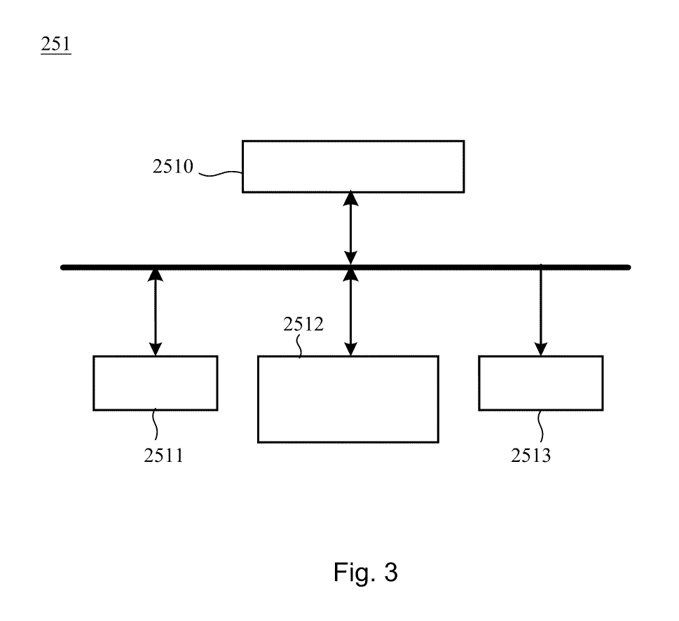

FIG. 3 illustrates a system structure of a graphic controller 251 according to the present invention. The graphic controller 251 includes a buffer memory 2510, a decoder 2511, a screen area zooming module 2512, and an encoder 2513. The buffer memory 2510 is to temporarily store data and an independent memory of the graphic controller 251 or memory resource of sharing the System memory (RAM) 23.

The image data from the video source 24 are temporarily stored in the buffer memory 2510; said image data include a plurality of compressed and encoded frame data. The decoder 2511 retrieves the image data from the buffer memory 2510 and decodes the image data into a plurality of original frame data, and then sends the plurality of frame data back to the buffer memory 2510 for temporary storage. The screen area zooming module 2512 acquires the plurality of original frame data from the buffer memory 2510 based on the control signals from the graphic driving program 441, and then, according to the information of the control signal, retrieves the image data corresponding to the specific area of a display frame content, continuously performs a zooming process on the specific area to enlarge the specific area, thus the plurality of original frame data are transformed to a plurality of target frame data to be sent back to the buffer memory 2510 for temporary storage. The encoder 2513 is to access the plurality of target frame data from the buffer memory 2510 and output the plurality of target frame data to the display screen 31 after the plurality of target frame data are encoded in the transmitting signal format of the visual interface 271.

A conventional graphic controller does not equip with a screen area zooming module, but simply can perform a zooming process according to respective the widths and heights of a display screen, so that the display frame content corresponding to the image data is able to fit with a display screen.

The graphic controllers 251, 252, 253, and 254 of the present invention respectively comprise an individual screen area zooming module. Each graphic controller transmits the plurality of original frame data into a plurality of target frame data based on the control signal requirement so as to retrieve the specific area of the display frame content corresponding to the image data and perform a zooming process on the specific area for presentation in conformity with respective the widths and heights of the display screen by their respective graphic controllers. The present invention enables the image division process to be performed by the graphic controllers 251, 252, 253, and 254 to share the workload of the central processing unit (CPU), so that the present invention can achieve the objective of performing the image division function via a single computer system.

The screen area zooming module of the present invention applies a digital signal processing technology to perform the retrieval of a specific area and a zooming process on a designated image. The screen area zooming module only selects the data corresponding to the specific area from the buffer memory, and performs the zooming process to the selected data so as to generate a plurality of target frame data. The zooming process for a display frame is able to be achieved by a wave filter.

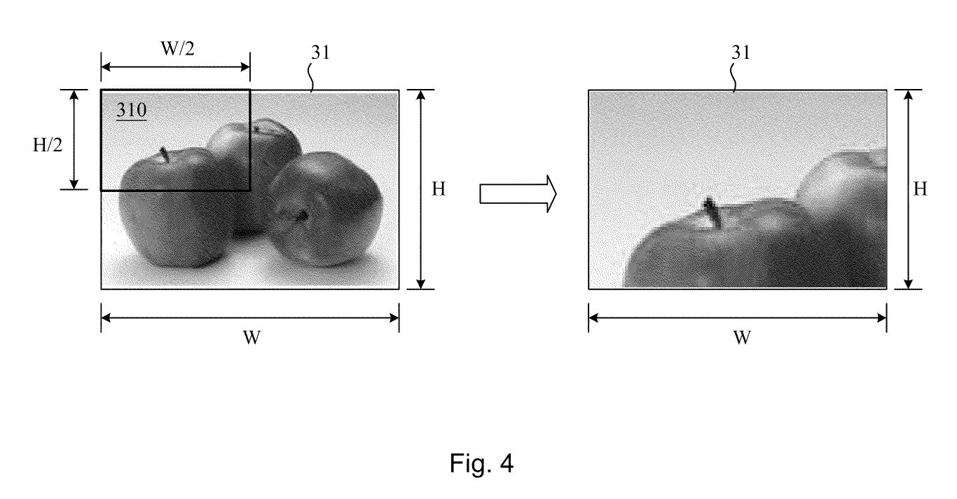

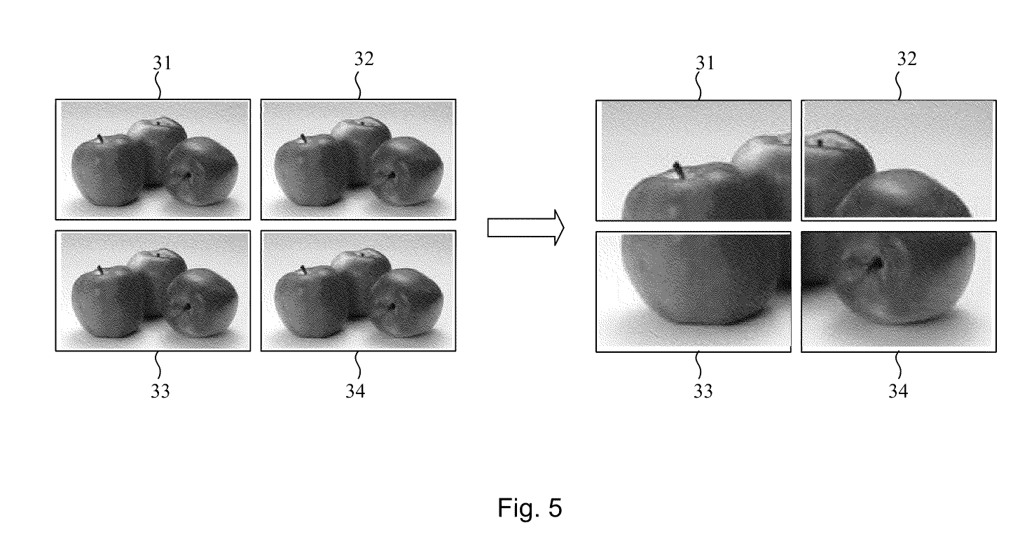

FIG. 4 is a perspective view showing an enlarge view of a portion of a single display frame according to the present invention; FIG. 5 is a perspective view showing the switch of display frames of an assembled display device according to the present invention.

With reference to FIG. 4, a display 31 comprises a screen height H and a screen width W. When a specific screen area 310 on the quarter area of the upper left of the display screen 31 is selected for presentation as a full screen, the information, the location coordinates, dimensions, etc., of the specific area 310 is inputted via the display frame setup program 43 to assemble a setup command. Generally speaking, the location coordinates on the upper left of a display frame is (0, 0) and the resolutions of the screen height H and screen width W are in pixels. In the preferred embodiment, the location coordinates on the upper left of a display frame (0, 0) and the dimensions of (W/2×H/2) are inputted through the user interface of the display frame setup program 43 to form a setup command. The specific area 310 of the display frame content corresponding to the image data is retrieved by the graphic controller 251; subsequently, the specific screen area 310 is enlarged and expanded to be presented on a full screen that is conformed to the display screen 31. Hence, the specific area 310 is able to be presented in a full-screen mode on the display screen 31.

With reference to FIG. 5, the location coordinates (W/2, 0), (0, H/2), (W/2, H/2) of the specific areas of the respective display screens 32, 33 and 34 on the upper right, lower left and lower right of a display frame content corresponding to the image data are inputted with the same screen dimensions (W/2×H/2). Therefore, the display screens 31, 32, 33, and 34 are able to present a full image data.

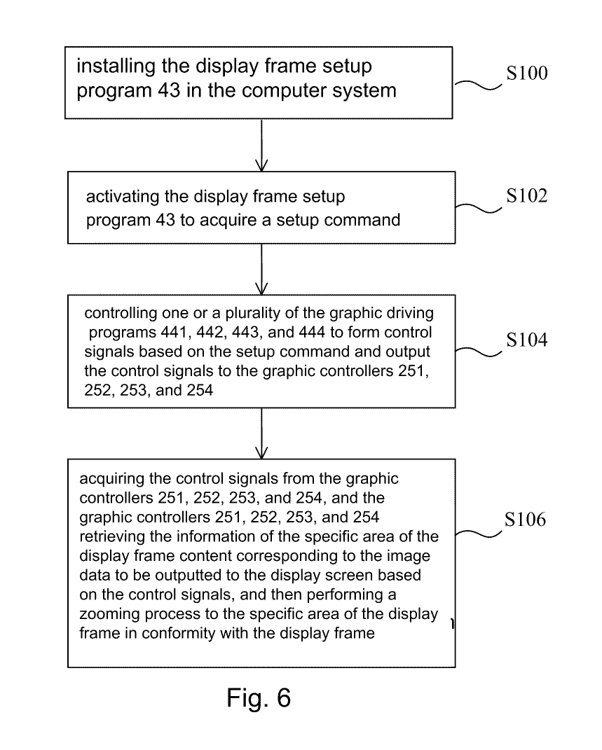

A display frame control method of the present invention is applicable to an assembled display device. With reference to FIG. 6, which illustrates a flow chart of the display frame control method of the assembled display device according to the present invention, and please refer to FIG. 1 and FIG. 2 for the structure of the system. The display frame control method of the invention is installed in a computer system and applied to an assembled display device 10. The assembled display device 10 includes the graphic controllers 251, 252, 253, and 254 to output the image data to the display screens 31, 32, 33, and 34. The display frame control method comprises the following steps of:

installing the display frame setup program 43 in the computer system (S100);

activating the display frame setup program 43 to acquire a setup command, which comprises the information of a specific area of a display frame content corresponding to the image data (S102);

controlling one or a plurality of the graphic driving programs 441, 442, 443, and 444 to form control signals based on the setup command and output the control signals to the graphic controllers 251, 252, 253, and 254 (S104), respectively; and

acquiring the control signals from the graphic controllers 251, 252, 253, and 254, and the graphic controllers 251, 252, 253, and 254 retrieving the information of the specific area of the display frame content corresponding to the image data to be outputted to the display screen based on the control signals, and then performing a zooming process to the specific area of the display frame in conformity with the display frame. (S106).

Prior to S102, there are the steps of: installing a multimedia display program 42 in the computer system; activating the multimedia display program 42 to acquire an image projection command; and based on the image projection command, controlling the graphic driving programs 441, 442, 443, and 444 to drive the graphic controllers 251, 252, 253, and 254 in order to output the image data to the display screens 31, 32, 33 and 34 for presentation.

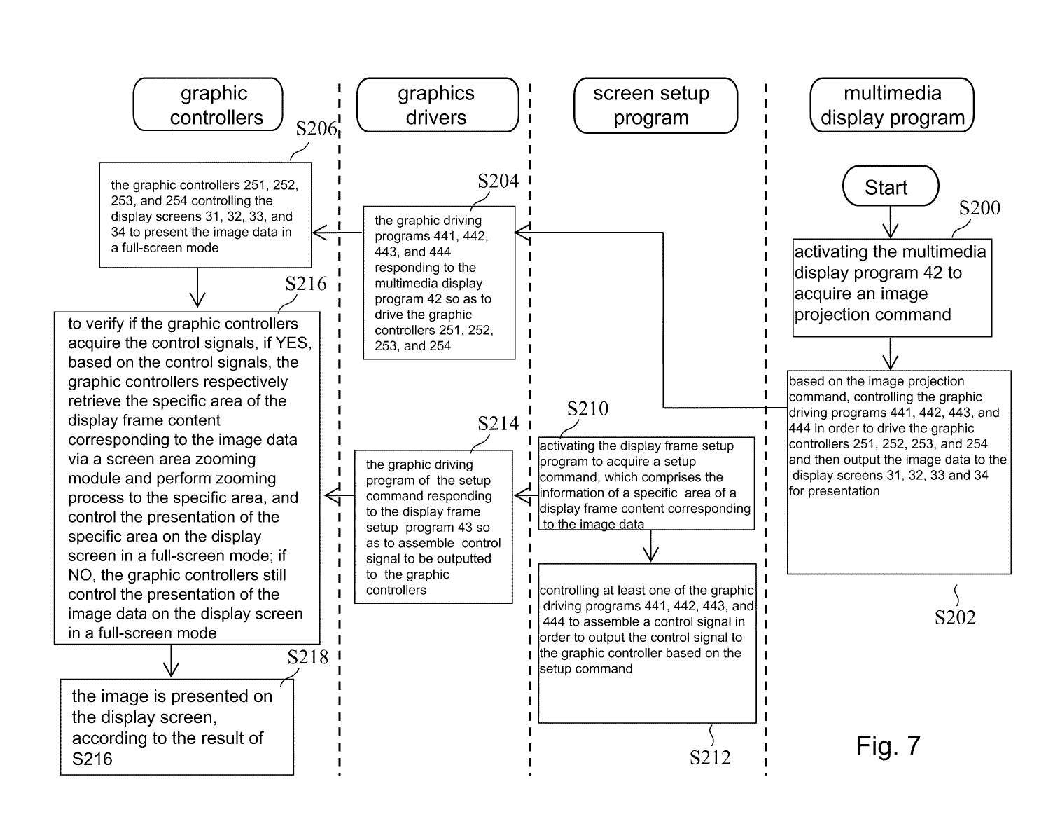

FIG. 7 illustrates a flow chart of the display frame control method of the assembled display device according to the present invention. In the preferred embodiment, the steps are of activating the multimedia display program 42 to acquire an image projection command (S200); based on the image projection command, controlling the graphic driving programs 441, 442, 443, and 444 in order to drive the graphic controllers 251, 252, 253, and 254 and then output the image data to the display screens 31, 32, 33 and 34 for presentation (S202); the graphic driving programs 441, 442, 443, and 444 responding to the multimedia display program 42 so as to drive the graphic controllers 251, 252, 253, and 254 (S204); and, the graphic controllers 251, 252, 253, and 254 controlling the display screens 31, 32, 33, and 34 to present the image data in a full-screen mode (S206).

On the other hand, the other steps are of activating the display frame setup program to acquire a setup command, which comprises the information of a specific area of a display frame content corresponding to the image data (S210); controlling at least one of the graphic driving programs 441, 442, 443, and 444 to assemble a control signal in order to output the control signal to the graphic controller based on the setup command (S212); and subsequently, the graphic driving program of the setup command responding to the display frame setup program 43 so as to assemble control signal to be outputted to the graphic controllers (S214).

After S206, the step is to verify if the graphic controllers acquire the control signals, if YES, based on the control signals, the graphic controllers respectively retrieve the specific area of the display frame content corresponding to the image data via a screen area zooming module and perform zooming process to the specific area, and control the presentation of the specific area on the display screen in a full-screen mode; if NO, the graphic controllers still control the presentation of the image data on the display screen in a full-screen mode (S216); at last, the image is presented on the display screen according to the result of S216 (S218).

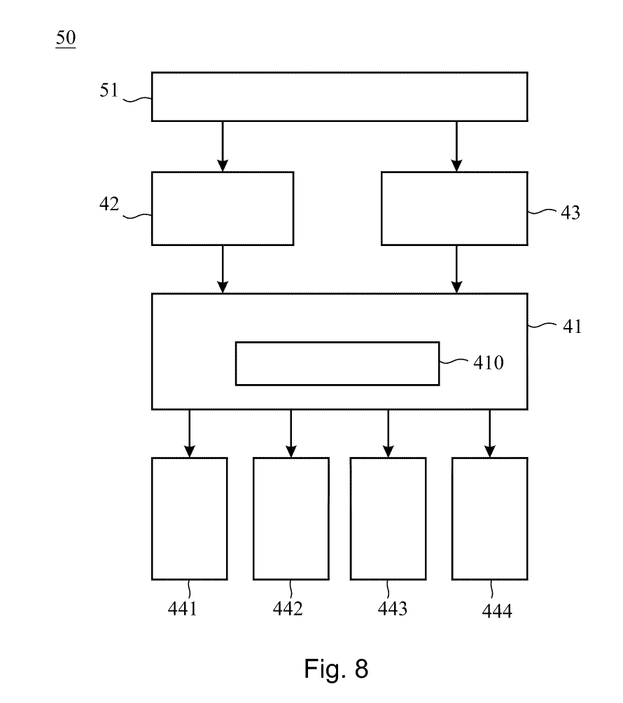

FIG. 8 illustrates a software system structure showing another preferred embodiment of the display frame control system of the assembled display device according to the present invention. In the preferred embodiment, a display frame control system 50 further comprises an assembled display controlling program 51, which is an application program installed in the computer system and able to jointly activate the multimedia display program 42 and the display frame setup program 43, in order to enable a quicker and smooth display frame setup operation.

In view of the foregoing, the assembled display device and the display frame control method and system thereof enable the image division process to be performed by the graphic controllers to share the workload of the central processing unit (CPU), so as to achieve the objective of performing the image division function via a single computer system. The present invention not only helps the reduction in system construction costs, but also the increase in the system maintenance for the convenience.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A display frame control method, which is applied to an assembled display device in a computer system, the assembled display device at least comprising a graphic controller for outputting image data to a display screen, the display frame control method comprising the steps of:
installing a display frame setup program in the computer system;
activating the display frame setup program to acquire a setup command, which comprises the information of a specific area of a display frame content corresponding to the image data;
controlling a graphic driving program to assemble a control signal in order to output the control signal to the graphic controller based on the setup command; and
the graphic controller retrieving the information of the specific area of the display frame content corresponding to the image data to be outputted to the display screen based on the control signal, and then performing a zooming process to the specific area of the display frame.

2. The display frame control method according to claim 1, wherein before the step of activating the display frame setup program comprising the further steps of:
installing a multimedia display program in the computer system;
activating the multimedia display program to acquire an image projection command; and
controlling the graphic driving program to activate the graphic controller in order to output the image data to the display screens based on the image projection command.

3. The display frame control method according to claim 2, further comprising the steps of:
installing an assembled display controlling program in the computer system; and
activating the assembled display controlling program to activate the multimedia display program and the display frame setup program.

4. The display frame control method according to claim 1, wherein the computer system has an operating system installed inside, the graphic driving program being installed in the operating system, the operating system has an application programming interface (API); the step of controlling the graphic driving program to assemble a control signal in order to output the control signal to graphic controllers based on the setup command further comprising the following steps:
the display frame setup program responding to the acquired setup command and generating a system call in order to control the graphic driving program to assemble the control signal from the graphic driving program to be outputted to the graphic controller through the application programming interface (API).

5. The display frame control method according to claim 1, wherein the graphic controller retrieves the specific area of the image data via a screen area zooming module, and perform the zooming process to the display frame of the specific area.

6. The display frame control method according to claim 1, wherein the setup command has the information on location coordinates and dimensions of the specific area.

7. A display frame control system, which is installed in a computer system to control at least a display screen, further comprising at least:
a graphic controller being coupled with the display screen;
a graphic driving program being installed in the computer system to activate the graphic controller;
a multimedia display program being installed in the computer system to control the graphic driving program to activate the graphic controller for the outputting image data to the display frame; and
a display frame setup program being installed in the computer system to acquire a setup command, which comprises the information of a specific area of a display frame content corresponding to the image data, the display frame setup program controlling the graphic driving program to assemble a control signal in order to output the control signal to the graphic controller based on the setup command;
wherein the graphic controller retrieves the information of the specific area of the display frame content corresponding to the image data to be outputted to the display based on the control signal, and then performing a zooming process to the display frame of the specific area of the display frame.

8. The display frame control system according to claim 7, wherein the computer system has an operating system installed inside, the graphic driving program being installed in the operating system, the operating system has an application programming interface (API), the display frame setup program responding to the acquired setup command and generating a system call in order to control the graphic driving program to assemble the control signal from the graphic driving program to be outputted to the graphic controller through the application programming interface (API).

9. The display frame control system according to claim 7, further comprising an assembled display controlling program, which is installed in the computer system to activate the multimedia display program and the display frame setup program.

10. The display frame control system according to claim 7, wherein the graphic controller comprises:
a buffer memory for temporarily storing the image data;
a decoder for accessing the image data from the buffer memory, decoding the image data into original frame data and outputting the frame data to the buffer memory for temporary storage;
a screen area zooming module for accessing the original frame data from the buffer memory, and transforming the original frame data into target frame data, then outputting the target frame data to the buffer memory for temporary storage based on the control signal; and
an encoder for accessing the target frame data from the buffer memory, and outputting the target frame data to the display after encoding the target frame data.

11. The display framed control system according to claim 7, wherein the graphic controller, based on the control signal, expands the specific d area of the display frame to a full-screen mode in conformity with the display frame.

12. The display frame control system according to claim 7, wherein the setup command has the information on location coordinates and dimensions of the specific area.

13. An assembled display device, which is installed in a computer system, comprising at least a display screen; and
a display frame control system, comprising:
a graphic controller being coupled with the display screen;
a graphic driving program being installed in the computer system to activate the graphic controller;
a multimedia display program being installed in the computer system to control the graphic driving program to activate the graphic controller for outputting an image data to the display frame; and
a display frame setup program being installed in the computer system to acquire a setup command, which comprises the information of a specific area of a display frame content corresponding to the image data, the display frame setup program controlling the graphic driving program to assemble a control signal in order to output the control signal to the graphic controller based on the setup command;
wherein the graphic controller retrieves the information of the specific area of the display frame content corresponding to the image data to be outputted to the display screen based on the control signal, and then performing a zooming process to the display frame of the specific area of the display frame.

14. The assembled display device according to claim 13, wherein the computer system has an operating system installed inside, the graphic driving program graphic driving program being installed in the operating system; the operating system has an application programming interface (API), the display frame setup program responding to the acquired setup command and generating a system call in order to control the graphic driving program to assemble the control signal from the graphic driving program to be outputted to the graphic controller through the application programming interface (API) graphic driving program.

15. The assembled display device according to claim 13, wherein the display frame control system further comprises:
an assembled display controlling program, which is installed in the computer system to jointly activate the multimedia display program and the display frame setup program.

16. The assembled display device according to claim 13, wherein the graphic controller further comprises:
a buffer memory for temporarily storing the image data;
a decoder for accessing the image data from the buffer memory, decoding the image data into original frame data and outputting the frame data to the buffer memory for temporary storage;
a screen area zooming module for accessing the original frame data from the buffer memory, and transforming the original frame data into target frame data, then outputting the target frame data to the buffer memory for temporary storage based on the control signal; and
an encoder for accessing the target frame data from the buffer memory, and outputting the target frame data to the display after encoding the target frame data.

17. The assembled display device according to claim 13, wherein the graphic controller, based on the control signal, expands the specific area of the display frame to a full-screen mode in conformity with the display frame.

18. The assembled display device according to claim 13, wherein the setup command comprises the information on location coordinates and dimensions of the specific area.
